(19) United States
(12) Patent Application Publication
(10) Pub. No.: US 2006/0054664 A1
(43) Pub. Date: Mar. 16, 2006

(54) Bipolar plate and method for the production thereof

(76) Inventors: Raimund Strobel, Ulm (DE); Hohe Kurt, Langenau (DE); Dominique Tasch, Neu-Ulm (DE); Bernd Gaugler, Neu-Ulm (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/514,367

(22) PCT Filed: May 13, 2003
(86) PCT No.: PCT/EP03/05012

§ 371 Date: May 11, 2005

(30) Foreign Application Priority Data
May 13, 2002 (DE) 1021951.6

(51) Int. Cl. B23K 31/02

(52) U.S. Cl. 228/179.1

(57) ABSTRACT

The invention relates to a bipolar plate (1) and to a method for the production thereof. Said bipolar plate has two plate-shaped metal sections (2a, 2b) which are connected to one another, forming a bipolar plate. Connection of the metal sections is done by means of laser beam welding.

The present invention relates to a bipolar plate for fuel cell systems, as well as to a method for manufacturing these bipolar plates.

With fuel cells, e.g. PEM fuel cells (polymer electrolyte membrane fuel cells) usually several fuel cells are layered onto one another into a fuel cell stack. Bipolar plates which effect the separation between the individual cells assume the following functions:
the electrical contacting of the electrodes of the fuel cells and further leading of current to the adjacent cell (series connection of the cells)
the supply of the cells with reaction gases and the transporting away of the produced water via a suitable channel structure (media distributor structure/flowfield),
the further leading of the waste heat arising with the reaction in the fuel cells, as well as
the mutual and external sealing of the various gas or cooling chambers.

It is known to manufacture bipolar plates of graphite materials essentially as one piece. The advantage of graphite materials lies in their high corrosion resistance and with regard to mobile applications also in their low material density. The susceptibility to tensile stresses and the brittleness of graphite materials which this entails however greatly restricts the choice of the shaping manufacturing method for the structuring. The shaping manufacture by way of machining with a material removal at the same time does not represent an option for inexpensive mass production.

Alternatively it is also possible to manufacture metallic bipolar plates of metals such as e.g. stainless steel, titanium and nickel. For this, two plate-like metal sections which have corresponding channel structures may be soldered or bonded to one another whilst forming a bipolar plate. At the same time, under certain circumstances due to the topography of the channel structures, a cavity is formed between the two metal sections, through which fluid may be led for cooling a fuel cell system.

The disadvantage with bipolar plates manufactured in this manner however is the fact that e.g. with bonded embodiments, the electrical conductivity between the bipolar plates is greatly compromised. A contamination by way of the flow means or solder may occur particularly with soldered embodiment forms. The welding of the plate-like metal sections, e.g. by way of TIG welding, due to the high heat input and the deformation of the metal sections which arises on account of this does not represent any-alternative since bipolar plates deformed in this manner no longer offer a smooth-surfaced contact surface and thus the efficiency of fuel cell systems which contain such warped bipolar plates is greatly reduced.

It is the object of the present invention therefore to create a quickly and inexpensively manufacturable bipolar plate which may be manufactured without warps and thus in a geometrically exact manner.

This object is achieved by a method according to claim 1 as well as a bipolar plate according to claim 17.

By way of the fact that laser beam welding effects the connection of the metal sections whilst forming a bipolar plate, no additional material is required in order to connect the metal sections to one another. Furthermore, no contamination by way of flow means, solder or adhesive takes place and these additional materials may also not block up the cavities arising between the channel structures (or the channels). Furthermore a high electrical conductivity of the bipolar plate perpendicular to the metal sections is possible since the transition resistance between the two welded metal sections is extremely low in the region of the welding. By way of this a high strength of the welding connection is also ensured.

A high degree of automisation is possible for the method and no additional working steps such as preparing the soldering locations or deposition of an adhesive is required. Accordingly, the process times may accordingly be kept short. One specific advantage of the laser beam welding lies in the fact that the power may be metered in an extremely good manner and a minimum input of heat as well as with very fine welding seams may be realised.

With the bipolar plate according to the invention it is particularly advantageous that the two metal sections to be welded to one another at least in regions comprise an interrupted seam for reducing the heat input on welding. By way of such an interrupted leading of the seam, the heat input into the metal sections may be realised to an as low extent as is required so that the warping due to heat may be limited to a tolerable measure.

Advantageous embodiments of the present invention are specified in the dependent claims.

One particularly advantageous embodiment of the method envisages carrying out the laser welding by way of a YAG laser (solid-body laser with which the base material consists of a Yttrium-aluminium-garnet), a CO₂-laser or a diode laser. At the same time it is advantageous for the laser beam in each case to be variable in its intensity. In particular with diode lasers a laser beam head with a multitude of diode lasers is suitable so that a welding is possible in a flash by way of a “laser flash” without movement of the laser beam head. At the same time a “mask” is particularly useful in order to protect the regions which are not to be welded.

One advantageous embodiment envisages the laser beam welding to take place in a laser beam welding device, wherein this comprises a clamping system for fixing the metal sections to be welded as well as a beam head for the exit of one or more laser beams.

At the same time the clamping system and/or the irradiation head may be selectively guided in a movable manner so that the clamping system or the beam head may be mutually displaced. This may be effected e.g. by way of an axis-guided Cartesian system which under certain circumstances may also be controlled automatically.

One particularly advantageous embodiment of the beam head envisages the beam head to comprise a movable mirror system for guiding the beam, wherein different regions of the metal sections to be welded may be selected in accordance with the mirror movement. By way of this (as a result of the low inertia of the mirrors), an extremely quick welding is possible, and without further ado 20-50 m per minute of welding seam may be realised on the metal sections. Empty run speeds of up to 1200 m/min are likewise also possible, which permits a very variable welding sequence.

One particularly advantageous embodiment of the clamping system according to the invention envisages the metal sections being embraced with a positive fit in regions. Already on account of this is a distortion of the metal sections by way of heat avoided. The formation of stiffening webs is possible for stiffening the positive fit clamping system. Furthermore the positive-fit embracing permits a large contact surface for the removal of heat, and the surface of the clamping system which is directed towards the metal section, for an improved heat removal, may be of a particularly good heat-conducting material such as e.g. copper or aluminium.

One advantageous embodiment of the clamping system envisages the plate-like metal sections to be arranged on one another without gaps during the laser welding. By way of the essentially flat, plate-like material sections lying on one another without gaps it is achieved that by way of the laser beam, the metal section lying closest to the beam head is not exclusively heated and under certain circumstances is even melted or burnt without assuming a connection with the part section lying further distanced to the beam head.

Furthermore, the clamping system may comprise a unit for leading protective gas onto the region to be welded. By way of this, any possible oxidation reaction which is set into action may be stopped, or a cooling of the metal sections may be achieved.

A particularly good limitation of the deformability of the metal section is achieved in that the clamping system on the upper side which faces the beam head comprises a radiation release for leading through a laser beam onto an upper-lying metal section. By way of this, on the one hand the access to the welding location is rendered possible, and on the other a leading away of heat is rendered possible, also in the immediate vicinity to this. For this it is also advantageous for the clamping system on the lower side distant to the beam head to provide a seizing (undesired) weld release in order to prevent the seizing (undesired) welding of a metal section on the positive-fit shape of the clamping system.

Particularly preferred embodiments of the method envisage an essentially peripheral welding to take place in the edge region of the metal sections, for creating a fluid-tight cavity between the essentially flat metal sections. Here it is preferably the case of a continuous seam, in particular at abutment locations (which e.g. may be necessary on reclamping large-surfaced metal sections in the clamping tool) it is possible to provide overlapping seams. For creating a coolant circuit, the cavity between the sections may comprise one or more openings for the supply and/or discharge of coolant.

It is particularly advantageous for the plate sections in the region of the cavity to comprise essentially gap-free connection locations. These may be provided almost as “islands” in the fluid circuit. The regions which here connect to one another, of the oppositely lying metal sections, at the same time are in each case connected by welding seams. These welding seams may have different shapes. Thus e.g. linear arrangements with welding points lying next to one another (point seams) are possible. It is however also possible to provide stitch quilt seams (as linear sections which are arranged behind one another but are distanced to one another). Point seams and stitch seams are particularly advantageous if a particularly low input of heat to the metal sections is intended.

It is however also to be observed that for the further leading of current through the bipolar plate (i.e. perpendicularly onto the essentially flat metal sections) a particularly good electrical connection between these two metal sections and an as low as possible transition resistance are to exist. This may preferably be achieved by wave-like seams (wave seams) which are to be deposited with the laser beam welding method.

One particularly advantageous embodiment envisages the thickness of the metal sections in the unwelded condition to be 0.05 to 3 mm. Stainless steel, titanium, nickel, nickel alloys or aluminium, in particular however stainless steel 1.4404 are to be considered as materials for the metal sections.

Further advantageous embodiments of the present invention are specified in the remaining dependent claims.

The invention is hereinafter explained by way of example and by way of one Figure. There are shown in

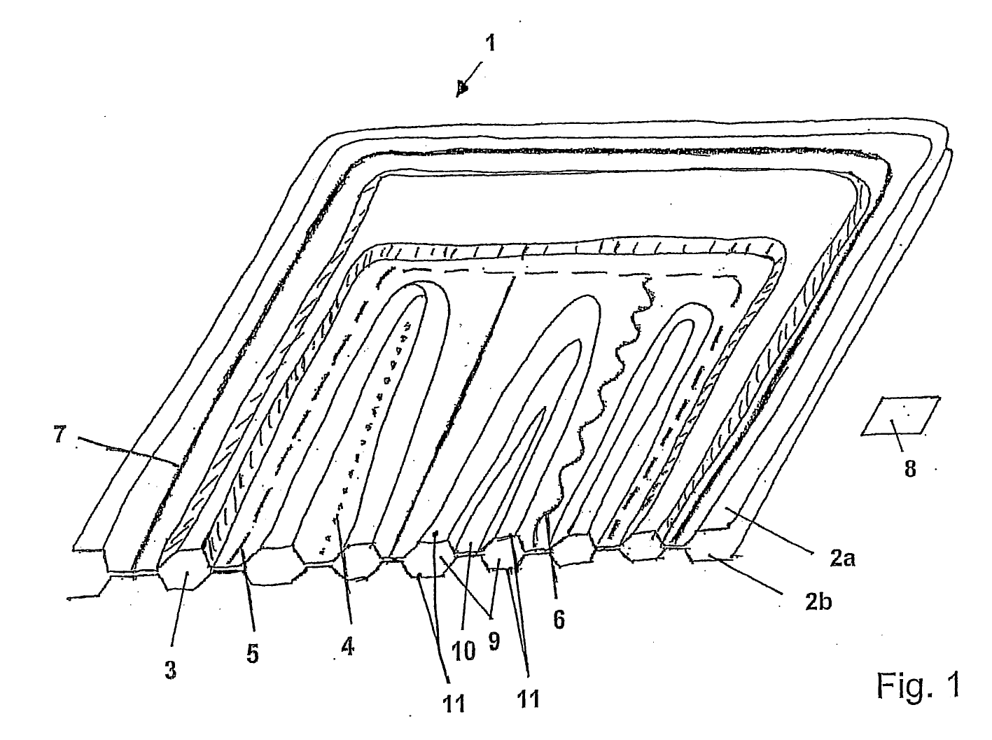

FIG. 1 an oblique view of a sectioned bipolar plate according to the invention, as part of a fuel cell system;

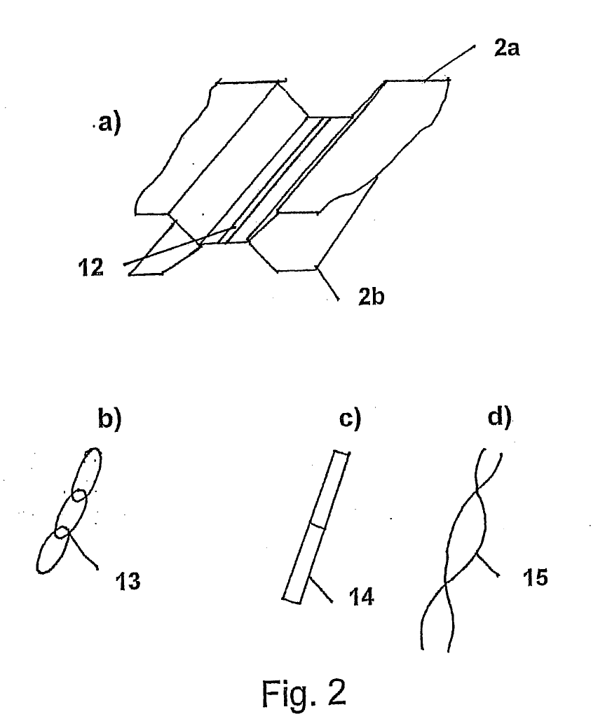

FIG. 2 various embodiment forms of double seal weld seams for bipolar plates according to the invention.

The figure in cross sections shows two essentially plate-like metal sections 2a and 2b. These metal sections have an essentially complementary shape, which with regard to the mirror plane 8 have a mirror-imaged shape, The plates need not be mirror imaged. What is important is the fact that a common contact surface is present which may be connected. The plate-like sections 2a and 2b have an uneven topology. By way of this, channel structures arise on the respective surfaces of the metal sections which point away from one another. Between the metal sections, on their surfaces pointing towards one another there is arranged a cavity 3 which consists of a system of several tunnels 9 which are connected to one another. The cavity 3 or the system of tunnels 9 is edged in a fluid-tight manner by a welding which is essentially peripheral around the edge region of the metal sections, wherein non-shown openings are provided for the supply and/or discharge of coolant.

The metal sections 2a and 2b are connected to one another by way of various welding seams. These on the one hand are stitch seams 5 which consist on linear sections which are rowed to one another. Furthermore point seams 4 are shown which consist of a row of weld points. Furthermore wave seams 6 are shown which have a continuous and essentially wave-like course. Finally a continuous seam 7 is shown given in an edge region. In the figure this continuous seam 7 is however not closed per se since merely a bipolar plate cut in the middle is shown for the purpose of an improved overview of the cavity 3.

All of the welding seams which are shown here have arisen by way of laser beam welding. With regard to details of the laser beam welding or the laser beam welding device in which this was effected, for the purpose of avoiding repetition, the introduction of the description is referred to, in full and explicitly, with the advantageous embodiments which were outlined there.

The thickness of the metal sections 2a, 2b in the unwelded condition is 0.05 to 3=. The sectioned bipolar plate shown in the Figure is of stainless steel. It is furthermore to be noted that for the interrupted seam designs shown here (i.e. the point seams 4 or the stitch seams 5) one may also apply other welding methods, such as e.g. point welding, roller seam welding and plasma welding, since with these forms of welding, already on account of the shaping, the heat input into the metal section of the bipolar plate is limited.

The bipolar plate may be a component of a fuel cell arrangement as has been described in the introduction. All of the components mentioned there may belong to a fuel cell system in which a bipolar plate 1 is layered. Here the channel structures 10 serve for distributing reaction gases or for transporting away the produced water (the channel structures 10 for a so-called “flowfield”). The channel structures 10 here comprise recesses between the tunnels 9 which comprise projections 11. E.g. diffusion layers for the distribution of gas or for leading further the current may be placed in a two-dimensional manner large onto these projections 11 and these layers are connected in a full-surfaced manner to electrodes of fuel cells which are deposited thereon.

The bipolar plate according to the invention in particular is characterised by the fact that on the one hand it may be manufactured in an inexpensive manner and on the other hand meets the high demands with regard the sealedness as well as the good further conduction of current through the bipolar plate.

FIG. 2 shows further embodiments of a bipolar plate according to the invention with double seal seams. Furthermore however further embodiments of multiple seal seams are possible. Basically therefore any numbers of seal welds lying next to one another may be realised. For emphasis, in FIG. 2a, example a) a cut-out of a bipolar plate according to the invention is shown, which shows parts of plate-like sections 2a as well as 2b, which in sections are connected to one anther via a double seal seams.

According to FIG. 2, example a) this double seal seam is realised by two weld seams running parallel to one another.

Examples b) to d) show various further possibilities for double seal seams. The course of the seam here is effected along the same path as the double seal seam 12 in example a). For an improved overview however in the examples b) to d) the courses of the welding lines have been shown (without bipolar plate).

Example b) shows a double seal [weld] seam 13. This consists of several weld lines which are closed in the shape of an oval, wherein the ovals connect linearly to one another and overlap in regions.

Example c) shows a double seal seam 14 with which rectangular chambers connect to one another and thus form the double seal seam 14.

Example d) shows two periodically crossing serpentine lines which form a double seal seam 15 which likewise separates individual chamber-like sections from one another.

For all of the examples a) to d) it is to be emphasised that with regard to the individual welding seam here, one may use all options as have been outlined above.

Furthermore the advantage of double seal seams lies in the fact that the fluid sealedness of this double seal seam is significantly increased in comparison to simple seams and also e.g. the electrical contact between the plate-like sections 2a and 2b.

The chamber systems according to examples b) to d) offer a particularly high sealedness, since this is ensured even with the leakage of individual chambers which are separated from one another.

One particularly advantageous aspect of the present invention is the minimisation of the heat input with the manufacture of bipolar plates since in particular with thin metallic plates a distortion is to be feared which is to be minimised at all events. Very thin metal plates amongst other things are used for the mobile field in which the weight play a very important role.

The minimisation is effected according to the invention in different manners.

On the one hand a laser beam welding device is to be provided which serves for interrupted seams for welding connection, in particular for laser welding connection of the two plates which make up the bipolar plate. Here “scanner welding” is particularly suitable. With this, as described above, a laser beam is deflected by way of a mirror so that practically without any loss in time spatial jumps on laser welding are possible, i.e. it is not necessary to draw a continuous welding seam. Here it is to be noted that alternately different regions of the plate are welded in order thus to achieve a homogenisation of the heat input with respect to space and time so that the plate is heated uniformly and not to a too sever extent during the welding procedure. This is of a considerable advantage with respect to a welding which proceeds from only one location, which would lead to a distortion of the bipolar plate.

Here furthermore the supply of protective gas also to the outer sides of the later bipolar plate is useful since by way of this the oxidation in the region of the welding seams is minimised and due to this, any subsequent oxide deposits which may hinder the flow of protons in a fuel cell membrane is avoided. The efficiency of a later bipolar plate is increased once again by way of this.

The interrupted welding lines may have the most varied of embodiments, one may provide a rowing of point-like weldings or also curved or straight welding lines or alternating welding lines and welding points. Here, it is optimal if the maximal distance between two welding elements (i.e. lines or points) is less than 2 cm, preferably less than 1.5 cm. The minimum length of welded regions at the same time should always be such that even with a high fluid pressure within the bipolar plate a secure retention of the two plates (and no “swelling”) is secured.

The main aspect (besides the fluid sealedness) is the electrical contact between both plates of the bipolar plate, primarily by way of avoiding longer flow paths.

For this, two plates are preferably applied onto one another without gaps in the laser beam welding device, and then welded to one another. By way of the large number of welding points, a short electrical path is given over the complete active field so that the efficiency of the fuel cell arrangement is high. Additionally however the mechanical stability is also increased. This too has several advantages. In particular with arrangements with which the fluid pressure in the cavity of the bipolar plate is significantly higher that the opposed gas pressure of the gaseous media, one thus achieves a stability which counteracts a “bloating” of bipolar plates. By way of this an improved pressing of the thus “planar” bipolar plates towards one another becomes possible and contact problems occur more rarely. Furthermore it is to be ascertained that by way of weldings in the region of the active field (i.e. chiefly e.g. of the cavity 3) directed in a targeted manner, the flow of media may be controlled by the weldings. This means than not only the gaseous media may be led on the outer side of the bipolar plate in a regulated manner, but also the coolant flowing within the cavity of the bipolar plate in order thus to achieve an even more uniform heat distribution and to further increase the efficiency of the fuel cell arrangement.

1. A method of manufacturing a bipolar plate for fuel cell systems, comprising:
laser beam welding a first plate-like metal section to a second plate-like metal section to produce a plurality of welding seams, wherein said welding seams include linear sections which are arranged behind one another and distanced to one another, and wherein predetermined portions of said plate-like metal sections are selectively maintained in contact during said laser beam welding for reducing the heat input of welding.

2-17. (canceled)

18. The method of claim 1, wherein the step of laser beam welding includes using one of a YAG-laser, CO₂ laser, and a diode laser.

19. The method of claim 1, further comprising the step of:
clamping said plate-like metal sections in a welding device with a clamping system, wherein said welding device includes a beam head to allow the exit of one or more laser beams, wherein said clamping system selectively maintains predetermined portions of said plate-like metal sections in contact during said laser beam welding.

20. The method of claim 19, wherein at least one of said clamping system and said beam head is moveably guided.

21. The method of claim 19, wherein said beam head comprises a moveable mirror system, and wherein different regions of said plate-like metal sections may be targeted by said laser beam by movement of said mirror system.

22. The method of claim 19, wherein said beam head is a diode laser tool.

23. The method of claim 19, wherein said clamping system selectively restricts movement of said plate-like metal sections.

24. The method of claim 19, wherein said clamping system selectively maintains predetermined portions of said plate-like metal sections in contact during said laser beam welding.

25. The method of claim 19, further comprising the step of supplying a protective gas to a region of said plate-like metal sections to be welded, wherein said clamping system includes a unit for selectively supplying said protective gas.

26. The method of claim 19, further comprising the step of releasing radiation from a region of said plate-like metal sections to be welded, wherein said clamping system includes a radiation release facing said beam head for selectively releasing said radiation.

27. The method of claim 19, further comprising the step of preventing a seizing welding of said plate-like metal sections, wherein said clamping system includes a seizing welding release for selectively preventing said seizing welding.

28. The method of claim 1, wherein the step of laser beam welding includes welding an end region of said plate-like metal sections in an essentially peripheral manner to create a fluid-tight cavity between said plate-like metal sections.

29. The method of claim 28, wherein said cavity comprises at least one opening for the flow of coolant.

30. The method of claim 1, wherein said plate-like metal sections have a thickness of between about 0.05 mm and about 3 mm.

31. The method of claim 1, wherein the material for said plate-like metal sections is selected from the group consisting essentially of stainless steel, titanium, nickel, nickel alloy, plated metallic materials, and aluminum.

32. The method of claim 28, further comprising the step of welding preselected regions of said plate-like metal sections adjacent said cavity, wherein said welding produces seams selected from the group consisting essentially of point seams, stitch seams, multi-seal seams, and wave seams.

33. The method of claim 1, further comprising the step of interrupting said laser beam welding, at least in regions, to reduce the heat input of said laser beam welding to said plate-like metal sections.

34. A bipolar plate comprising:
a first plate;
a second plate; and
a plurality of welding seams connecting predetermined portions of said first plate and said second plate, wherein said welding seams include linear sections which are arranged behind one another and distanced to one another, and wherein predetermined portions of said plate-like metal sections are selectively maintained in contact during said laser beam welding.

35. A welding device, comprising:
a clamping system for selectively maintaining predetermined portions of a plurality of plate-like metal sections in contact during laser beam welding;
a beam head for the exit of one or more laser beams for the deposition of welding seams, wherein said welding seams include linear sections which are arranged behind one another and distanced to one another, and wherein said predetermined portions of said plate-like metal sections are selectively maintained in contact during said laser beam welding.
